(19) United States
(12) Patent Application Publication
(10) Pub. No.: US 2008/0218078 A1
(43) Pub. Date: Sep. 11, 2008

(54) Cooled High-Pressure Gas-Discharge Lamp

(75) Inventors: Holger Monch, Vaals (NL); Jan Alfons Julia Stoffels, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N. V., Eindhoven (NL)

(21) Appl. No.: 10/500,491

(22) PCT Filed: Dec. 18, 2002
(86) PCT No.: PCT/IB02/05507

§ 371 Date: Dec. 10, 2007

(30) Foreign Application Priority Data
Jan. 2, 2002 (DE) 102 00 026.3

(51) Int. Cl. H01J 17/20

(52) U.S. Cl. 313/568

(57) ABSTRACT

The invention relates to a cooled high-pressure gas-discharge lamp, at least comprising a cooled envelope (43) that seals off hermetically a discharge chamber (431) filled with a gas, there being, at least in the discharge chamber (431), a non-uniform temperature distribution at the time of the gas discharge, and comprising a cooling means (7) having a coolant, which cooling means (7) produces a directed flow (9) of coolant, there being a liquid coolant acting on the envelope (43) of the lamp, it being possible for the lamp to be operated at a higher power, and the flow (9) of coolant being such that, when the power consumption of the lamp is increased, any devitrification of the envelope (43) of the lamp and any condensation of the gas is substantially prevented.

The invention relates to a cooled high-pressure gas-discharge lamp that at least comprises a cooled lamp envelope that seals off hermetically a discharge chamber filled with a gas, there being, at least in the discharge chamber, a non-uniform temperature distribution at the time of the gas discharge, and that comprises a cooling means having a coolant, which cooling means produces a directed flow of coolant.

Because of their optical properties, there is a preference for using high-pressure gas-discharge lamps (high-intensity discharge (HID) lamps and particularly ultra-high performance (UHP) lamps) for projection purposes.

What is required for such applications is a light source that is as point-like as possible so that the length of the arc that forms between the tips of the electrodes will not be more than approximately 0.5 to 2.5 mm. What is also desirable is light that is of the greatest possible strength and of a spectral composition that is as natural as possible.

Such properties can best be achieved at the present time with UHP lamps. However, in developing lamps of this kind, there are two essential requirements that both have to be met at the same time:

On the one hand, the maximum temperature at the inner surface of the discharge chamber must not be so high that there is any devitrification of the envelope of the lamp, which is generally made of quartz glass. This may present problems because the region above the arc is heated with particular intensity due to the high convection within the discharge chamber of the lamp.

On the other hand, the coldest point on the inner surface of the discharge chamber (arc chamber) must still be at a temperature sufficiently high for the mercury not to deposit there but instead for an adequate amount of it to remain, overall, in a vaporized state. Particular attention must be paid to this point in lamps having saturated gas fillings.

These two contradictory requirements mean that the maximum permissible difference between the highest and lowest temperatures (generally at the top and bottom inner faces of the discharge chamber) is relatively small. However because, due to internal convection, it is mainly the region above the discharge chamber that is heated and because the limits within which the latter's thermal conductivity can be increased by suitable design of the envelope of the lamp are only narrow, it is relatively difficult to maintain this maximum difference and tight limits are set for any increase in the performance of the lamp. It is possible in principle for an increase in performance of this kind to be achieved by using air cooling but, due to the physical properties of air, there are only certain amounts of heat that can be taken away from the envelope of the lamp in this case.

Air-cooled lamps are familiar from lighting engineering generally. In DE 190 31 17 for example, there is described an air-cooled short-arc lamp forming a floodlight. This floodlight, which has a reflector for a lamp operating at the focus of the reflector and which has an approximately point-like light source of high power giving a high luminance, is cooled by using nozzles to blow air onto the envelope of the lamp. The teaching conveyed makes express reference to the assumption made by those skilled in the art that high-performance short-arc lamps of this kind have to have artificial air-cooling.

It is an object of the invention to provide a high-pressure gas-discharge lamp of the kind mentioned in the first paragraph, and particularly a UHP lamp or lighting unit suitable for projection purposes, that at least retains its spectral properties within a widened power or performance range.

This object of the invention is achieved by virtue of the facts that a liquid coolant acts on the envelope of the lamp, the lamp can be operated at a higher power and the flow of coolant is such that, when the power consumption of the lamp is increased, any devitrification of the envelope of the lamp and any condensation of the gas is substantially prevented.

A major advantage of this solution is not only that the light retains its spectral properties at a high level but also that the lamp operates at a higher working voltage, which means that a correspondingly higher lamp power is obtained at the same lamp current. On the other hand, if the lamp power remains the same only a lower current is required. As a result, the life of the electrodes, which are normally subject to particularly heavy wear at the electrode spacings of approximately 0.5 to 2.5 mm that are of interest for projection applications, is now substantially longer.

Because a liquid coolant, such as, for example, water or a mixture containing water, is used it is possible to obtain better Figs. for heat transmission per unit of time. A premise for the selection of the liquid coolant was that no significant changes should be caused in the spectral properties of the light. The nature of the flow of the coolant, such as, for example, the way in which it makes contacts with defined regions of the envelope of the lamp, has a major influence on the desired conduction of heat away from the envelope of the lamp.

In accordance with the invention, attention is focused particularly on those regions of the envelope of the lamp that are at the highest temperatures while the lamp is working. Allowance has to be made for the particular position in which the lamp is installed, such as horizontally or vertically for example, because this has a major influence on the temperature distribution within temperature field in the discharge chamber and hence in the envelope of the lamp. A further criterion for the sizing and design according to the invention of the cooling system is the degree to which the temperature distribution is homogenized in the discharge chamber.

An advantage of the solution according to the invention is that the lamp and the cooling means can be operated in such a way that they are matched to one another. This relates in particular to the output power to which the lamp is set, which can be increased by a factor of between approximately 2 and 10 in comparison with its power rating when not cooled without there being any observable devitrification of the envelope of the lamp. What the matched operation, achieved for example by the use of a feedback circuit, ensures is that if a decline in the lamp voltage is detected, the cooling is reduced in such a way that any condensation of mercury is prevented.

The dependent claims relate to advantageous refinements of the invention. A particularly advantageous embodiment of the invention is a high-pressure gas-discharge lamp that is in the form of a short-arc lamp and is used for projection purposes.

In cases where the power consumption of the lamp can or has to be adjustable to variable settings, it is useful for the flow of coolant that is produced by the cooling means to be controlled in a manner defined as a function as of the power consumption of the lamp. Also, or as an alternative, it is preferable for the operation of the cooling means to be such that the coolant moves in a conventional closed circuit.

The cooling is most effective when that flow of coolant is directly straight onto at least a region of the envelope of the lamp that is situated above the discharge chamber and is thus regularly at the highest temperature.

Where the lamp is installed in a horizontal position, it is preferable for more or all of the flow of coolant to be directed onto the region that is situated above the opposing tips of the electrodes in an electrode arrangement. It is possible for more of the flow of coolant to be directed onto this region by means of, for example, a so-called outer envelope, in which case higher volumetric flowrates can occur in the flow of coolant in the upper region of the outer envelope than in its lower region.

Where the lamp is installed in a vertical position, it is preferable for more or all of the flow of coolant to be directed onto the region that is situated above the tip of the upper electrode in an electrode arrangement. The flow of coolant may be preferentially guided to the region of the lead-through of the upper electrode. It is particularly useful for the flow of coolant to be guided in this way because only a very small amount of light is emitted in this region of the envelope of the lamp. The cooling by the liquid thus has only a minor effect on the relevant parameters of the light.

It is also preferable for the region that is above the discharge chamber when the lamp is in a particular installed position to have a better heat-transfer coefficient than the region situated below the discharge chamber. This can be achieved by, in particular, arranging means in the region above and/or below the discharge chamber and/or sizing the envelope of the lamp, in such a way that the heat-transfer coefficient at the points in question can be acted to further the aims of the invention. Means of this kind that are known per se from thermal and insulation engineering are, for example, insulating layers or films applied to the outer surface of the envelope of the lamp. The heat-transfer coefficient can generally be acted on even more effectively in this way. Non-transparent coatings may also be used away from the main cone of light from the lamp and particularly in the neighborhood of the points at which the electrodes are led through. The heat-transfer coefficient can be acted on substantially more effectively in this way.

It is preferable for there to be arranged, in the region below the discharge chamber, means that reduce the heat-transfer coefficient of that region of the envelope of the lamp that is situated at the bottom, such as, for example, transparent layers or films applied to the body of the glass.

With this in mind, it is also preferable for the wall thickness of the region situated above the discharge chamber to be increased down to the region situated at the bottom. With the envelope of the lamp installed in a horizontal position, it is therefore preferable for the wall thickness of the region that is situated above the opposing tips of the electrodes in an electrode arrangement to be increased down to the region situated at the bottom.

The embodiments defined in claims 4 to 7 allow the effectiveness of the cooling to be further improved, thus enabling the lamp power to be further increased and the other properties of the lamp, such as the spectrum of the emitted light or the arc voltage, to at least remain as they are.

Another aspect of the invention, which is dealt with in claims 8 and 9, aims at a very high degree of homogenization of the temperature distribution within the discharge chamber itself, thus enabling a lamp envelope that is fundamentally unchanged in comparison with the prior art to be used.

In this connection, it is preferable for the homogenization of the temperature distribution in the discharge chamber to take place as a result of the lamp being rotated about the imaginary horizontal axis extending between the opposing tips of the electrodes.

Alternatively, homogenization of the temperature distribution in the discharge chamber may take place as a result of the lamp being operated in the region of so-called acoustic resonances. The acoustic resonances are made use of in this case in a known manner, as described in U.S. Pat. No. 5,880,561 and U.S. Pat. No. 6,225,724 for example, to prevent the arc from curving upwards and thus to reduce the temperature differential in the envelope of the lamp.

The object of the invention is also achieved by a lighting unit having at least one high-pressure gas-discharge lamp as claimed in any of claims 1 to 9.

A lighting unit of this kind may be used in particular for projection purposes when powers of above 400 W and up to 7000 W are required. Uncooled high-pressure gas-discharge lamps are unsuitable for projectors requiring particularly bright lights (e.g. electronic cinemas) and there are limits to how far air-cooled lamps of this kind are suitable.

These and other aspects of the invention are apparent from and will be elucidated with reference to the embodiments described hereinafter.

In the drawings:

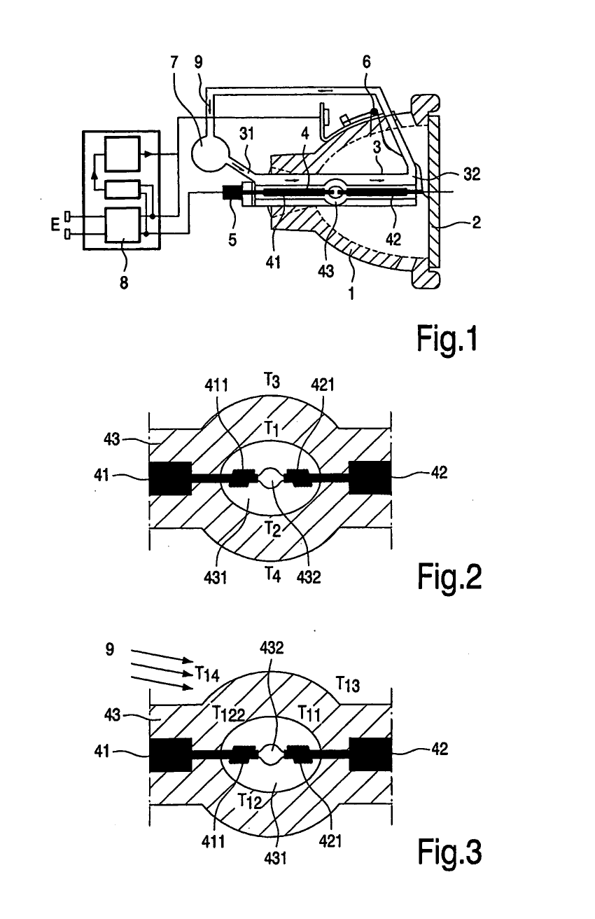

FIG. 1 is a diagrammatic view of the high-pressure gas-discharge lamp (UHP lamp) in section.

FIG. 2 shows the temperature distributions that arise in the region of the discharge chamber when there is no cooling, and

FIG. 3 shows a temperature distribution in the region of the arc chamber for the electrodes when there is cooling in accordance with the invention.

FIG. 1 is a diagrammatic cross-section through a UHP lamp according to the invention with the lamp fitted in a horizontal position. The UHP lamp has a reflector-equipped housing 1, whose opening is preferably closed off by a front glass 2. The front glass 2 forms an exit face for the light and serves to protect the surroundings in the event of the lamp destroying itself. It can also be designed to act as a filter for the light generated.

An electrode arrangement 4 extends from the end of the reflector-equipped housing 1 opposite from the opening into the housing 1. In essence, the electrode arrangement 4 comprises a first electrode 41 and a second electrode 42, which electrodes are situated in a lamp envelope 43, and between the opposing tips of the electrodes 41, 42 an arc discharge is excited in a discharge chamber 431 in the lamp envelope 43. The other ends of the electrodes 41, 42 are connected to respective ones of the electrical connections 5, 6 of the lamp, via which the supply voltage required to operate the lamp is fed in by a power supply 8.

As well as the electrode arrangement 4, there is also a cylindrical outer envelope 3 that extends into the reflector-equipped housing 1. The outer envelope 3 has an inlet 31 and an outlet 32 via which the liquid coolant is recirculated in a closed cooling circuit. The cooling means 7 comprises all the components required for a conventional coolant circuit, such as at least one coolant reservoir, a pump, inlet and outlet members, a cooling unit if necessary, temperature measuring facilities and suitable connecting ducts. The electrical and electronic components mentioned of the cooling means 7 normally have at least one power supply and control system and are often networked by means of data systems. The inlet 31 is connected to a circulating pump to enable the latter to produce a flow of the liquid between the inlet 31 and outlet 32. At a defined volumetric throughput through the outer envelope 3, water at an inlet temperature adapted to the particular operating conditions of the lamp is fed in through the inlet 31. As a result of, in particular, the arrangement of the inlet 31 and the geometrical characteristics of the outer envelope 3, the flow of coolant is directed onto the region of the lamp envelope 43 that is to be cooled. The outlet 32 is arranged in the vicinity of the electrical connection 6, particularly to enable the outlet 32 to be situated outside the cone of light from the lamp.

The lamp according to the invention is operated by the power supply 8, which is suitable for a general line-supply voltage. The power supply 8 comprises a first driver circuit for supplying the lamp and a second driver circuit for operating a source producing the flow 9 of coolant. Also provided are monitoring and control facilities by which the lamp voltage applied to the lamp is measured. Alternatively, the second driver circuit may be combined with the source to produce a separate cooling unit, in which case the monitoring and control facilities will preferably have an output terminal that is intended for connection to the cooling unit and at which there is an information signal, which may be digital for example, giving the lamp voltage and power.

To allow the operation of the cooling system according to the invention to be elucidated, the region of the discharge chamber 431 of the electrode arrangement 4 will first be explained in detail by reference to FIG. 2. FIG. 2 shows the mutually opposing regions of the electrodes 41, 42 and their tips 411, 421, which extend into the discharge chamber 431 of the lamp envelope 43 and between which an arc 432 forms when the lamp is in its operating state.

In this state, the discharge chamber 431 and the surrounding regions of the lamp envelope 43, and particularly its wall regions, are heated to different degrees. The highest temperature T1 at the lamp envelope 43 occurs at that inside face of the discharge chamber 431 that is at the top when the lamp is operating in a horizontal position, whereas the temperature T2 at the opposite, bottom inside face of the discharge chamber 431 is lower than T1. Due to the temperature gradient through the wall of the lamp envelope 43, which is generally composed of quartz glass, the temperature T3 at the top, outer face of the lamp envelope 43 is lower than that T1 at the inside face at that point, but is at the same time the highest temperature on the outside of the lamp envelope 43. Finally, the temperature T4 at the bottom, outer face of the lamp envelope 43 is likewise lower than that T2 at the bottom, inside face. The points mentioned are indicated in the figures by the reference letters and numerals T1 to T4. The relationships which thus arise are, amongst others: T2<T1, T1>T3 and T2>T4.

When designing the lamp and optimizing the light yield, allowance must be made for the fact that the above temperatures have to meet the following conditions:

The highest temperature T1 at the top inside face of the lamp envelope 43 must not be so high that there is any risk of the quartz glass devitrifying. On the other hand, the lowest temperature T2 at the bottom inside face of the lamp envelope 43 must be sufficiently high for the mercury not to deposit there but to remain in vapor form. It is true of the difference T1−T2 between these two temperatures that it is determined by the convection and heat transmission in the hot plasma. What this means is that the difference is proportional to the gas pressure in the discharge chamber 43 and is thus a critical factor, particularly in UHP lamps.

To obtain the properties and advantages of the lamp according to the invention that were mentioned at the beginning, an attempt is made to achieve a gas pressure (pressure of the mercury vapor) that is as high as possible. Under the following formula, this pressure is a function of the temperature T of the coldest point in the discharge chamber 431: p_{Hg}[bar]=2.5*10⁵ e^{-8150 K/T}.

An increase in the gas pressure is thus produced by raising the temperature of the coldest point in the discharge chamber 431. To enable the lamp to be operated at an appropriately increased power, it is a provision of the invention for a liquid coolant to act on the envelope 43 of the lamp, the coolant flow being such that any devitrification of the interior of the lamp envelope 43 and any condensation are substantially avoided.

With this cooling, a coolant flow 9 as indicated by the arrows in FIG. 3 is directed in particular onto the region above the discharge chamber 431. This results in a change in the temperature distribution. The highest temperature T3 on the outside of the lamp envelope 43 is reduced by the cooling to a temperature T13 and at the same time is shifted on the outside in the direction of flow. Similarly, the highest temperature T1 on the inside of the lamp envelope 43 is reduced to a temperature T11 and is shifted in the direction of flow. The lowest temperature T14 on the outside of the lamp envelope 43 is situated at the point where the coolant flow 9 impinges on the lamp envelope 43. Inside the discharge chamber 431, at the bottom side thereof, the temperature T12 is shifted in the opposite direction to the direction of flow or, when the flow is particularly powerful, a temperature T122 can be found at the top side thereof, shifted in the opposite direction to the direction of flow, as a lowest temperature.

With the cooling according to the invention, it is possible for the lamp power to be increased without this causing any increase in the highly critical maximum temperature T1 at the top outside face of the lamp envelope 43. Even in the event of the temperature T11 rising due to unforeseen circumstances and causing local devitrification of the lamp envelope 43, this will not interfere with the usable cone of light because, as shown in FIG. 3, it will be situated in the region that is masked off by the electrodes.

Because of the increased power to the lamp, there is no drop in the temperature T2 of the coldest points in the discharge chamber 431, despite the additional cooling. There is thus no condensation of the mercury over a wide range of parameter values. For this, it is essential for the coolant flow and the lamp power to be set simultaneously, with the coolant flow generally being controlled as a function of the lamp power. If the lamp were simply cooled (even if the cooling were selectively directed onto its upper side) without its power being increased, the mercury would at once condense, particularly in the lamps used in the present case that have a saturated gas filling, and the properties of the lamps would thus be degraded to an unwanted extent.

It has also been found that a UHP lamp sized for a rated power of 150 watts can even be operated at 400 watts without the temperatures inside the discharge chamber 431 exceeding their critical limits. All in all, it was found that the maximum (increased) power of such lamps could be increased appreciably beyond 400 watts without the other properties of the lamps being adversely affected. Generally speaking, when cooling is employed the output power of the lamps can be increased by a factor ranging from 2 to approximately 10. It may also be advisable for the size of the electrodes to be adjusted to suit the higher currents that are possible.

The source producing the coolant flow 9 may be a simple steplessly variable circulating pump that is suitably sized to enable the requisite volumetric throughput and hence, with flow passages of known geometries, the requisite speed of flow, to be obtained.

A further advantage of the present cooling is that, if the cooling continues for, for example, approximately 10 to 30 seconds after the lamp is switched off, the gas (the mercury) condenses relatively quickly and the internal gas pressure thus decreases. The condensation takes place in this case not on the electrodes but on the inner wall of the lamp envelope 431. This makes it possible for the lamp to be relit only a few seconds after it has been switched off with a relatively low striking voltage.

To obtain as high as possible an output power from, and a high operating pressure in, the lamp for a lamp envelope 43 and a discharge chamber 431 of a given size, cooling that is as intensive as possible, and thus a high coolant flow 9, are required. However, a limit is set in this regard by the condensation of the mercury in the discharge chamber 431. It has, however, been found that the beginning of condensation at the coldest point in the discharge chamber 431, which need not necessarily be situated at the bottom side of the latter, can be detected by monitoring any decline in the lamp voltage. In this way, by analyzing the lamp voltage detected by the monitoring and control means and feeding it back to the second driver circuit, it is possible to control the coolant flow 9 in such a way that although it is as high as possible it is not so high that condensation, which would have an adverse effect on the properties of the lamp, will appear at a light output from the lamp set by the first driver circuit. Conversely, the light output from the lamp can thus be maximized by optimizing the cooling, a stable state of operation then being set by feedback.

A further advantage of the combination of the lamp according to the invention with a power supply 8 of the kind described above is obtained when the lamp is operated at different light outputs. Particularly in cases where the lamp is dimmed, by making an appropriate reduction in the cooling in the manner described above the optimum operating conditions (gas pressure) can be maintained in the discharge chamber 431. As a result of this, there is no adverse effect on the properties of the lamp, particularly with regard to the color spectrum of the light radiated, even at a reduced light output. The usable dimming range for the UHP lamps according to the invention, which amounts to only up to approximately 80% of the maximum light output in the case of known UHP lamps, is extended in this way because any condensation of mercury can be largely avoided by an appropriate reduction of the cooling as a function of a sensed decline in the voltage across the lamp. There is a limit that is set in practice for this reduction in the cooling and that is to be found in the physical properties of the liquid coolant and particularly the transition between the liquid and gas phases.

1. A cooled high-pressure gas-discharge lamp, at least comprising a cooled lamp envelope (43) that seals off hermetically a discharge chamber (431) filled with a gas, there being, at least in the discharge chamber (431), a non-uniform temperature distribution at the time of the gas discharge, and comprising a cooling means (7) having a coolant, which cooling means (7) produces a directed flow (9) of coolant, characterized in that a liquid coolant acts on the envelope (43) of the lamp, the lamp can be operated at a higher power and the flow (9) of coolant is such that, when the power consumption of the lamp is increased, any devitrification of the envelope (43) of the lamp and any condensation of the gas is substantially prevented.

2. A high-pressure gas-discharge lamp as claimed in claim 1, characterized in that the high-pressure gas-discharge lamp is a short-arc lamp for projection purposes.

3. A high-pressure gas-discharge lamp as claimed in claim 1, characterized in that the flow (9) of coolant is controlled, and/or is driven in a closed circuit, by the cooling means (7) as a function of the power consumption of the lamp.

4. A high-pressure gas-discharge lamp as claimed in claim 1, characterized in that the coolant flow (9) is directed straight onto at least a region of the lamp envelope (43) that is situated above the discharge chamber (431) and is at the highest temperature.

5. A high-pressure gas-discharge lamp as claimed in claim 1, characterized in that the region that is above the discharge chamber (431) in the particular installed position of the lamp has a better heat-transfer coefficient than the region situated below the discharge chamber (431).

6. A high-pressure gas-discharge lamp as claimed in claim 5, characterized in that means are arranged in the region below and/or above the discharge chamber (431), and/or the lamp envelope (43) is sized, such that the heat-transfer coefficient at the point(s) in question can be acted on.

7. A high-pressure gas-discharge lamp as claimed in claim 6, characterized in that the wall thickness of the region that is situated above the discharge chamber (431) increases down to the region situated at the bottom.

8. A high-pressure gas-discharge lamp as claimed in claim 1, characterized in that homogenization of the temperature distribution in the discharge chamber (431) takes place as a result of the lamp being rotated about the imaginary axis extending between the opposing tips (411, 421) of the electrodes.

9. A high-pressure gas-discharge lamp as claimed in claim 1, characterized in that homogenization of the temperature distribution in the discharge chamber (431) takes place as a result of the lamp being operated in the region of so-called acoustic resonances.

10. A lighting unit for lighting and/or projection purposes having at least one high-pressure gas-discharge lamp as claimed in claim 1.
